(19) United States
(12) Patent Application Publication
(10) Pub. No.: US 2015/0091819 A1
(43) Pub. Date: Apr. 2, 2015

(54) TOUCH STRUCTURE AND MANUFACTURING METHOD FOR THE SAME

(71) Applicant: E INK HOLDINGS INC., Hsinchu (TW)

(72) Inventor: Shih-Yu WANG, Hsinchu City (TW)

(73) Assignee: E INK HOLDINGS INC., Hsinchu (TW)

(21) Appl. No.: 14/278,717

(22) Filed: May 15, 2014

(30) Foreign Application Priority Data
Oct. 1, 2013 (TW) 102135522

(51) Int. Cl. G06F 3/041

(52) U.S. Cl. CPC G06F 3/041; G06F 2203/04103
USPC 345/173

(57) ABSTRACT

A touch structure and a manufacturing method for the same are provided. The touch structure includes a substrate, a sensing pattern and a dummy pattern. The dummy pattern and the sensing pattern are disposed in the same level on the substrate.

This application claims the benefit of Taiwan application Serial No. 102135522, filed Oct. 1, 2013, the subject matter of which is incorporated herein by reference.

### BACKGROUND OF THE INVENTION

1. Field of the Invention

The invention relates in general to a touch structure and a manufacturing method for the same, and more particularly to a touch structure with dummy pattern and a manufacturing method for the same.

2. Description of the Related Art

Touch panels have been widely used in many fields such as home appliance, communication devices and electronic information devices. By sliding on a touch panel with a finger or writing on the touch panel with a stylus pen, the user can input signals to operate a device. As the consumers' requirement in the quality of touch panel gets higher and higher, the display effect of touch panel needs to be increased accordingly to meet the market demand.

### SUMMARY OF THE INVENTION

The invention is directed to a touch structure having the advantages of lower cost and superior optical characteristics and a manufacturing method for the same.

According to one embodiment of the present invention, a touch structure is provided. The touch structure comprises a substrate, a sensing pattern and a dummy pattern. The dummy pattern and the sensing pattern are disposed in the same level on the substrate.

According to another embodiment of the present invention, a manufacturing method for a touch structure is provided. The manufacturing method comprises concurrently forming a sensing pattern and a dummy pattern on a substrate.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a cross-sectional view of a touch structure according to an embodiment.

FIG. 1A shows a cross-sectional view of a touch structure according to an embodiment.

FIG. 2 is a plan view of a touch structure according to an embodiment.

FIG. 3 is a plan view of a touch structure according to an embodiment.

### DETAILED DESCRIPTION OF THE INVENTION

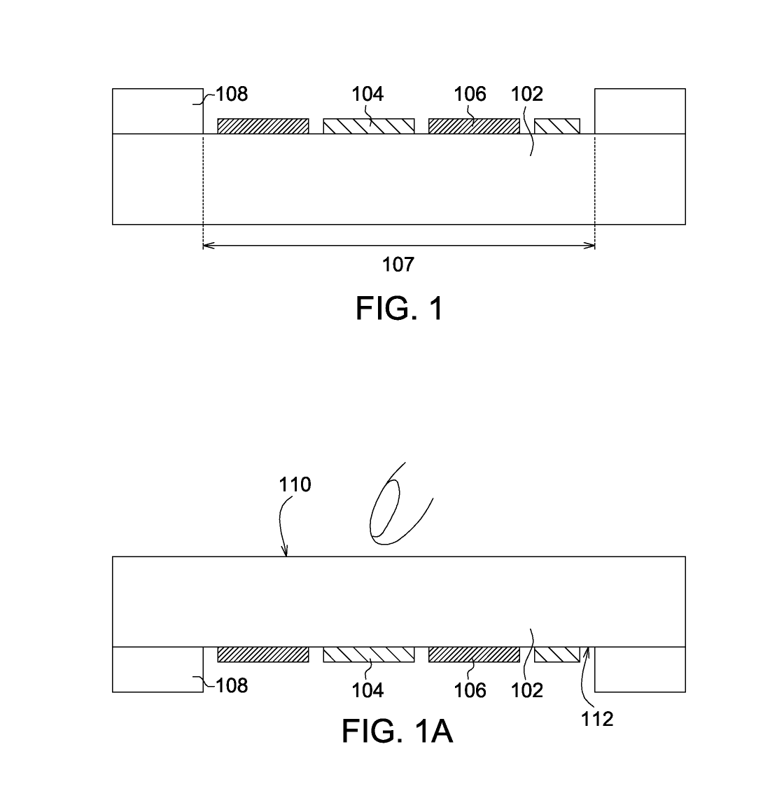

Referring to FIG. 1, which is a cross-sectional view of a touch structure according to an embodiment, the touch structure comprises a substrate 102, a sensing pattern 104 and a dummy pattern 106. The sensing pattern 104 and the dummy pattern 106 are separated from each other, and are disposed in the same level on the substrate 102 and located in a display region 107. The structure of on glass sensor (OGS) simplifies the stacking structure and reduces the volume, weight and manufacturing cost of touch panel. The touch structure may comprise a black matrix (BM) 108 disposed outside the display region 107.

In an embodiment, the substrate 102 is a transparent substrate, for example, formed by glass or other suitable materials. The sensing pattern 104 and the dummy pattern 106 are electrically isolated from each other, and are formed by the same conductive material such as transparent indium tin oxide (ITO) or aluminum zinc oxide (AZO), etc. In an embodiment, a manufacturing method for the touch structure comprises following steps. A conductive film is formed on the display region 107 of the substrate 102. Then, the conductive film is patterned to concurrently form the sensing pattern 104 and the dummy pattern 106. The manufacturing method is simple, incurs low cost and produces high conformity rate.

The sensing pattern 104 having driving and receiving functions is electrically connected to an external circuit via respective corresponding conductive traces (not illustrated). The dummy pattern 106 homogenizes the overall brightness of the frame, and can choose not to be electrically connected to any electrodes or conductive traces or can be grounded or electrically connected to any fixed reference electrodes or floating electrodes. The conductive traces can be formed by a metal such as copper, etc, or any suitable materials.

The substrate 102 is applicable to a front glass of a touch type transparent display. As indicated in FIG. 1A, the sensing pattern 104 and the dummy pattern 106 are disposed on a surface 112 of the substrate 102, wherein the surface 112 is different from the touch surface 110. Through the graphical configuration of the sensing pattern 104 and the dummy pattern 106, a complicated structure, such as an insulation layer, a metal layer or a protection layer, which would otherwise be used can now be omitted to reduce the use of the mask and achieve the effect on the simplicity of process.

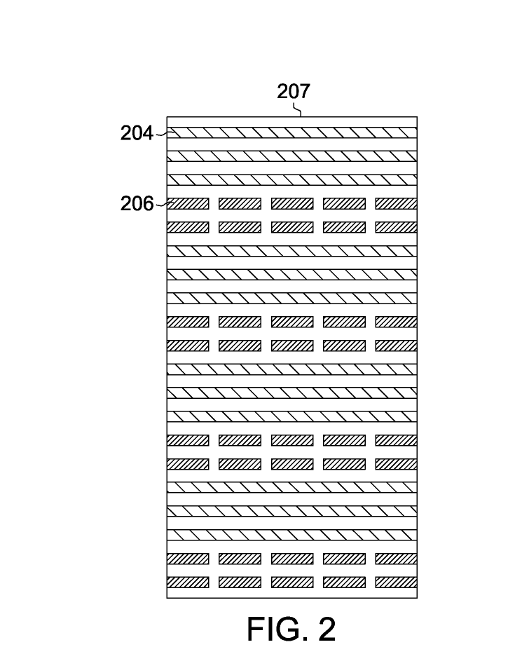

Referring to FIG. 2, a plan view of a touch structure according to an embodiment is shown. In the present embodiment, each of the sensing pattern 204 and the dummy pattern 206 disposed in the display region 207 comprises a regularly arranged pattern as indicated in the diagram. The sensing pattern 204 and the dummy pattern 206 are not limited to stripe pattern, and can be realized by any other suitable patterns such as circular pattern, rectangular pattern, triangular pattern, hexagonal pattern, or octagonal pattern. In an embodiment, through suitable graphical configurations and adjustment in the density thereof, the touch structure can advantageously possess superior optical characteristics, such as high transmittance and low reflectivity, and the pattern of the touch structure can hardly be detected with naked eyes. The sensing pattern 204 is electrically connected to an external circuit via respective corresponding conductive trace (not illustrated). The dummy pattern 206 can choose not to be electrically connected to any electrodes or conductive traces, or can be grounded or electrically connected to any fixed reference electrodes or floating electrodes. In an embodiment, the route of the conductive traces can be suitably disposed to enhance the optical effect of the touch structure. The design principle regarding graphical configuration is as follows. The sensing pattern 204 is irregularly disposed in the display region 207 with lower reflection, and then the dummy pattern 206 is interposed into the part of the sensing pattern 204 in the region 207 with lower density, so as to homogenize the overall brightness of the frame.

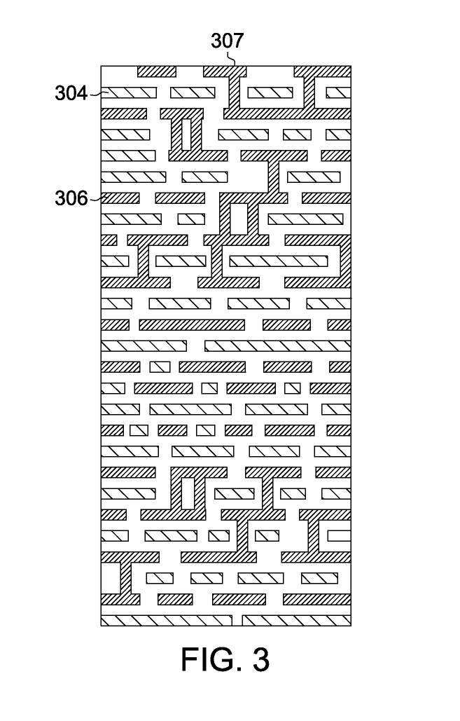

Referring to FIG. 3, a plan view of a touch structure according to an embodiment is shown. In the present embodiment, each of the sensing pattern 304 and the dummy pattern 306 disposed in the display region 307 comprises irregularly arranged patterns as indicated in the diagram. The sensing pattern 304 and the dummy pattern 306 are not limited to stripe pattern, and can be realized by any other suitable patterns such as circular pattern, rectangular pattern, triangular pattern, hexagonal pattern, or octagonal pattern. In an embodiment, through suitable graphical configurations and adjustment in the density thereof, the touch structure can advantageously possess superior optical characteristics, such as high transmittance and low reflectivity, and the pattern of the touch structure can hardly be detected with naked eyes. The sensing pattern 304 is electrically connected to an external circuit via respective corresponding conductive trace (not illustrated). The dummy pattern 306 can choose not to be electrically connected to any electrodes or conductive traces, or can be grounded or electrically connected to any fixed reference electrodes or floating electrodes. In an embodiment, the route of the conductive traces can be suitably disposed to enhance the optical effect of the touch structure.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch structure, comprising:
a substrate;
a sensing pattern; and
a dummy pattern, wherein the dummy pattern and the sensing pattern are disposed in the same level on the substrate.

2. The touch structure according to claim 1, wherein the sensing pattern is electrically insulated from the dummy pattern.

3. The touch structure according to claim 2, wherein the dummy pattern comprises a regular pattern.

4. The touch structure according to claim 2, wherein the dummy pattern comprises an irregular pattern.

5. The touch structure according to claim 2, wherein the sensing pattern comprises a regular pattern.

6. The touch structure according to claim 2, wherein the sensing pattern comprises an irregular pattern.

7. The touch structure according to claim 1, wherein the substrate is a transparent glass substrate and comprises a black matrix region and a display region, and the sensing pattern and the dummy pattern are disposed in the display region.

8. The touch structure according to claim 1, wherein the sensing pattern and the dummy pattern are formed by a conductive material.

9. The touch structure according to claim 1, wherein the sensing pattern and the dummy pattern are formed by the same material.

10. A manufacturing method for a touch structure, comprising:
forming a film on a substrate; and
patterning the film to concurrently form a sensing pattern and a dummy pattern on the substrate, wherein, the sensing pattern is electrically insulated from the dummy pattern.
